(19) United States
(12) Patent Application Publication
(10) Pub. No.: US 2013/0062044 A1
(43) Pub. Date: Mar. 14, 2013

(54) FLUE GAS AIR PREHEATER, AND A METHOD FOR INSTALLATION, AS WELL AS AN AIR PIPE COMPONENT FOR A FLUE GAS AIR PREHEATER

(71) Applicants: Jan Nickull, Siivikkala (FI); Vesa Kainu, Kangasala (FI)

(72) Inventors: Jan Nickull, Siivikkala (FI); Vesa Kainu, Kangasala (FI)

(73) Assignee: METSO POWER OY, Tampere (FI)

(21) Appl. No.: 13/699,653

(22) PCT Filed: May 19, 2011
(86) PCT No.: PCT/FI2011/050457

§ 371 Date: Nov. 23, 2012

(30) Foreign Application Priority Data
May 28, 2010 (FI) 20105604

(51) Int. Cl. F28F 1/00; B23P 11/00

(52) U.S. Cl. 165/177; 29/402.08

(57) ABSTRACT

A flue gas air preheater and a method for the installation of air pipes for a flue gas air preheater. The method includes cutting an air pipe connected to the preheater and detaching the portion of the air pipe that is to be removed from the preheater for replacement; fitting a separate new air pipe in place of the air pipe portion to be removed; and connecting the new air pipe to the remaining portion of the air pipe in a sealed manner. The fixing may be performed utilizing a fastening sleeve fixed to the end of the new air pipe and inserting it in the remaining portion of the air pipe. The fixing may be performed by a mechanical sealing solution without welding. The air pipe component for the flue gas air preheater includes an air pipe, and a fastening sleeve.

### FIELD OF THE INVENTION

The invention relates to a method for the installation of air pipes of a flue gas air preheater. Furthermore, the invention relates to a flue gas air preheater. The invention also relates to an air pipe component for a flue gas air preheater.

### BACKGROUND OF THE INVENTION

For preheating combustion air for a large solid fuel boiler, flue gas air pre-heaters (German Luftvorwärmer, LUVO) are typically used, in which the heating medium, i.e. flue gas, flows outside heat exchanger pipes, and the medium to be heated, i.e. air, flows inside the heat exchanger pipes. The heat exchanger pipes, which are also called air pipes in this description, are typically placed horizontally in the flue gas duct, and a large number of heat exchanger pipes constitutes a heat exchanger unit. Heat exchanger units on different height levels are connected to each other by air ducts placed outside the flue gas duct. There are also configurations, in which the flue gas flows inside the heat exchanger pipes, and the heat exchanger pipes are vertical.

In known configurations, the temperature of the air pipe is significantly low on the air inlet side, at the initial end of the air pipe. The considerable cooling effect of air at the inlet end of the air pipe is due to the fact that at the point of inflow, the heat transfer coefficient of the flow is multiple compared to the developed flow deeper in the pipe. Furthermore, the air supplied to the air pipe has not yet been substantially warmed at the initial end of the air pipe. Strong cooling causes a relatively low material temperature on the air inlet side of the heat exchanger unit of the preheater, in spite of the fact that the average temperature of the flue gases is relatively high. Thus, at the surface of the heat exchanger unit, particularly on the surface of the air pipes, a temperature can be achieved that corresponds to the acid dew point of the flue gases. Reaching the acid dew point, in turn, causes strong corrosion in the cold heat exchanger structure because of condensed water and sulphuric acid, and eroding through in a short time, particularly with difficult fuels. In particular, the joint between the coldest air pipe and the end plate connected to it may be corroded, if the temperature of the material is too low. Said end plate is simultaneously part of the wall of the flue gas duct.

At the cold end (air inlet side, initial end of the air pipe) of the coldest air pipes, various insulation sleeves fitted around the outer surface of the air pipe have been provided to prevent corrosion of the air pipe. In addition, various protective sleeve structures, for example with thermal insulations, have been placed inside the air pipe.

After the corrosion has, notwithstanding the precautions, proceeded too far, the method of prior art has been to remove the air pipe from service by blocking it. However, this is merely a temporary remedy. Typically, however, repairing involves removing the whole heat exchanger unit containing hundreds of air pipes, the so-called LUVO block, from the flue gas duct and replacing the whole LUVO block. It is obvious that said operation is very demanding, because the weight of the heat exchanger unit may be even 150 tons, and the length of the air pipe may be, for example, 6 m. In connection with the replacement, new air pipes are connected at their both ends to the two end plates of the LUVO block.

It is obvious that the replacement and repair of the whole LUVO block will cause a long downtime of the boiler, and the work cannot be done in connection with other, shorter interruptions in operation.

### BRIEF SUMMARY OF THE INVENTION

In the following, a solution will be presented to avoid the replacement of the whole LUVO block in connection with the repair and replacement of air pipes.

To achieve this aim, the method for the installation of air pipes of a flue gas air preheater according to the invention is characterized in what will be presented in claim 1. The flue gas air preheater according to the invention is characterized in what will be presented in claim 10. The air pipe component for a flue gas air preheater according to the invention is characterized in what will be presented in claim 15.

In one embodiment of the implementation, the air pipe to be replaced is cut at its one end, at least, to a given length in such a way that a new air pipe is fixed between the end plate and the remaining air pipe. Typically, the end plate is also replaced by a new one, at least in part.

The advantage of the presented solution is that the whole LUVO block does not need to be replaced. With this solution, the portion of the air pipes to be replaced may typically be only 15 tons of the total weight of the LUVO block.

The new and old air pipes are joined to each other in a desired way, for example by forming the end of the new air pipe as a right cone, for example by a machine tool for the pipe end. The cone is fitted tightly into the end of the old air pipe, making use of the conical shape and an installation method whose principles partly correspond to the method of installation of a sleeve that will be described in the following. The replacement of merely the end or a part of the air pipe is performed more easily and faster than the replacement of the whole air pipe.

According to a particular example, the new air pipe is connected to a fastening sleeve that is tubular and is placed inside the new and the old air pipe. By means of the fastening sleeve, a single continuous air pipe is formed. In one example method of fixing, the principle is particularly that the tightness of the fixing between the fastening sleeve and the old air pipe is based on mechanical sealing in which the old air pipe is not connected to the fastening sleeve by welding. In practice, welding would be impossible, because the air pipes are placed close to each other in the LUVO block.

According to some examples, the sealing is provided either by the conical shape of the fastening sleeve, or by one or more O rings of the fastening sleeve, or by both. The conical outer jacket of the fastening sleeve is sealed against the inner surface of the old air pipe when the installation is performed by applying a sufficient force. The new air pipe is then connected to the end plate in the desired way.

In one example, the fastening sleeve is a half-finished tubular fastening sleeve blank that is connected to the new air pipe, typically by welding, in such a way that part of the fastening sleeve blank is left inside the end of the new air pipe and part of the fastening sleeve blank remains as an extension outside the end of the new air pipe. The fastening sleeve blank is machined, typically by lathing, when it is connected to the new air pipe. In this way, simple measures can be taken to secure that the new air pipe, the installed fastening sleeve and the cylindrical or conical outer surface of the fastening sleeve are concentric. In this way, it is particularly avoided that the fastening sleeve would be fixed to the old air pipe in a slanted position, which would, in turn, cause problems in securing the mechanical sealing.

In connection with the replacement of the air pipe, an air guide sleeve can be inserted in the initial end of the air pipe, the air guide sleeve being made of a poorly heat conductive material and designed to diminish turbulence in the air flow. The air guide sleeve is adapted to guide the combustion air to be heated in contact with the inner surface of the air pipe at a distance from the initial end of the air pipe. In this way, the cooling of the outer surface of the initial end of the air pipe and the warming of air in the air pipe takes place over a longer distance and more evenly.

The tubular fastening sleeve can even be installed in new LUVO blocks, in which case the fastening sleeve is used for connecting new air pipes to each other. This will facilitate the replacement of the air pipe later. When there is a need for replacing the air pipe, the initial end of the air pipe, with the sleeve, is detached from the rest of the air pipe without cutting. In this way, the cutting point of the air pipe can be straightened and the inner surface can be calibrated to the desired length more easily and with fewer measures than by performing the cutting of the air pipe by shearing, for example with a rotary cut off tool.

In an example, the initial end of the air pipe or other points which are critical in view of corrosion can be provided by the above-presented system with a material that differs from the material of the rest of the air pipe. In this way, it is possible to have a significant effect on the total lifetime of the pipe or to perform testing of materials.

In one example, the materials of the fastening sleeve and the air pipe are selected, in view of thermal expansion, in such a way that sufficient sealing is maintained at different temperatures. In particular, the material of the fastening sleeve preferably has a greater thermal expansion coefficient than the air pipe.

### DESCRIPTION OF THE DRAWINGS

In the following, the invention will be described in more detail with reference to the appended principle drawings, in which

FIG. 1 shows a system utilizing the combustion of solid fuel in a principle view,

FIG. 2 shows an embodiment of a flue gas air preheater in a principle view,

FIG. 3 shows a cross-section of one air pipe and an air guide sleeve in a flue gas air preheater,

FIG. 4 shows the placement and structure of air pipes in a flue gas air preheater,

FIG. 5 shows an example of a fastening sleeve blank, in a side view,

FIG. 6 shows an example of a fastening sleeve connected to an air pipe, and

FIG. 7 shows an example of a fastening sleeve connected to an air pipe consisting of two different portions.

For the sake of clarity, the drawings only show the details necessary for understanding the implementation. The structures and details which are not necessary for understanding the implementation but are obvious for a person skilled in the art, and in which it is possible to apply principles or devices known as such, have been left out from the drawings.

### DETAILED DESCRIPTION OF THE EMBODIMENTS OF THE INVENTION

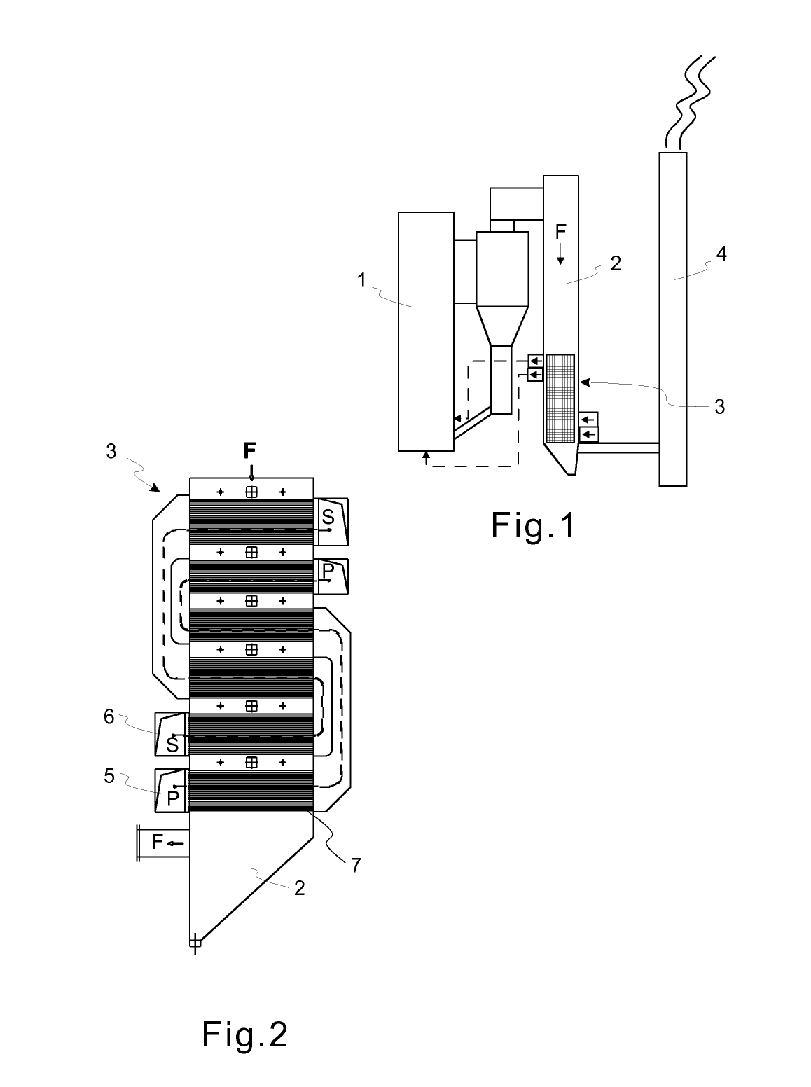

FIG. 1 shows, in a principle view, a system for producing and utilizing thermal energy, for example a boiler, that makes use of combustion of solid fuel. The system comprises a furnace 1, in which the combustion of the fuel takes place, a flue gas duct 2, to which the flue gases formed in the combustion are led, a flue gas air preheater 3, by which the combustion air used in the combustion is heated before it is introduced in the furnace, and a stack 4. The preheater 3 is placed in the flue gas duct 2. As can be seen from the figure, the preheater 3 is placed at the terminal end of the flue gas duct 2 in the flow direction F of the flue gases.

FIG. 2 shows an embodiment of the preheater 3 in more detail. In this example, the air flows S, P to be heated are guided into the preheater 3 from air supply areas 5, 6 in the lower part. The heated air is discharged from the upper part of the preheater 3. In the example, the preheater 3 comprises two air circulations, i.e. a primary air circulation P and a secondary air circulation S. Both air circulations P, S comprise air pipes 7 which are placed horizontally in the flue gas duct 2, and the heat exchanger units on different levels are connected to each other by channels outside the flue gas duct 2.

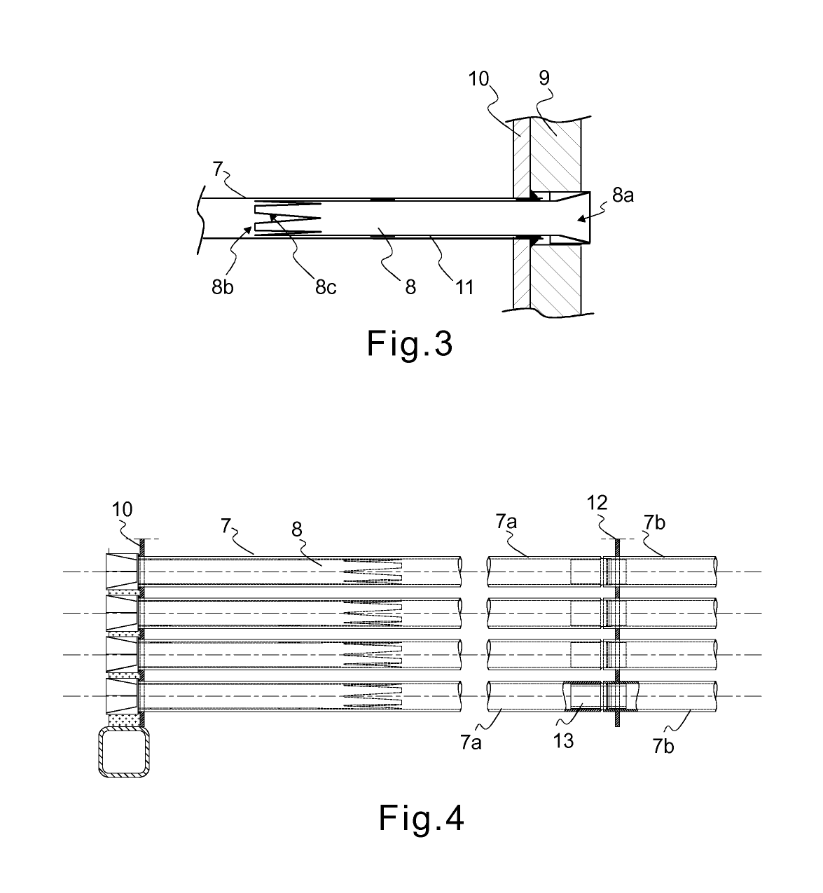

FIG. 3 shows the initial end of one air pipe of the flue gas air preheater 3 in a cross-sectional view. A heat exchanger unit in a typical vertical flue gas duct 2 comprises 20 to 30 pipes 7 on top of each other and about a hundred pipes adjacent to each other. FIG. 3 shows the initial end of the air pipe 7, and in this example, an air guide sleeve 8 is also installed in it. In the example, the air pipe 7 extends a short distance (about ⅓ of the length) into an insulation layer 9 that surrounds the flue gas duct 2. The air pipe 7 is, for example, welded or mangled in a gas tight manner to the end plate 10 or the wall of the flue gas duct 2. In the example, the air guide sleeve 8 extends through the insulation layer 9, and the outer surface of the air guide sleeve is connected tightly to the end of the air pipe 7. For example, silicone can be used for sealing. The inflow end 8a of the air guide sleeve 8, i.e. the inlet of the air flow, is shaped as a funnel in this example. In the embodiment shown in FIG. 3, a clearance 11 is provided between the air guide sleeve 8 and the air pipe 7. The structure of the terminal end of the air pipe 7 corresponds to that shown in FIG. 3, but the air guide sleeve is not necessary.

The length of the air guide sleeve 8 is typically more than 3 to 8 times the diameter of the air pipe 7. The diameter of the air pipe 7 is, for example, about 50 mm. The outer end 8b of the air guide sleeve 8 that is placed inside the air pipe 7 is shaped so as to induce no significant turbulence in the air flow discharging from the air guide sleeve. In the example, the end 8b of the air guide sleeve is shaped so that the portion of the wall from the surface area limited by the outer circumference of the pipe decreases towards the end 8b.

FIG. 4 shows in more detail some of the air pipes 7 in the heat exchanger unit of the preheater 3, particularly their initial end which is placed between an intermediate support 12 in the preheater and the end plate 10. The lowest air pipe 7 is shown opened, to make the fastening sleeve 13 more visible. The distance between the intermediate support 12 and the end plate 10 is, for example, 1300 mm, but it may vary. The initial ends of the air pipes 7 have been removed by cutting the air pipe 7 and by removing part of the air pipe 7. The remaining portion of the air pipe 7 forms, in this description, a part that is called the old air pipe 7b. The central part and the terminal end of the air pipe 7 remain in place. Typically, the old air pipe 7b extends through the intermediate support 12. That portion of the air pipe 7 which is to be replaced constitutes the part that is called the new air pipe 7a in this description. The initial end of the air pipe 7 is a separate new air pipe 7a which is connected to the old pipe 7b by means of a tubular fastening sleeve 13. The new and old air pipes are joined to each other in such a way that they are as parallel and concentric as possible. The initial end of the air pipe 7 is connected to the end plate 10.

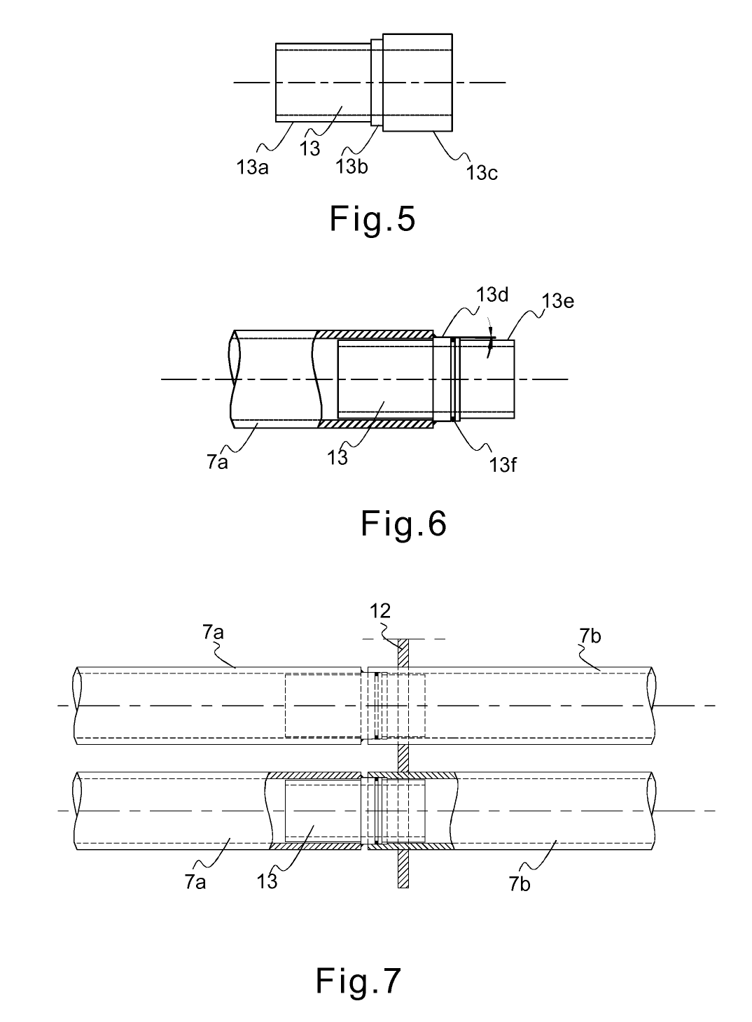

FIG. 5 shows, in more detail, an example of a fastening sleeve blank 13 whose first end 13a is ready machined, for example by lathing, so that it could be installed in the new air pipe 7a as shown in FIG. 6. The fastening sleeve blank 13 is made of, for example, a tube, and its material is steel. The fastening sleeve blank 13 is a tubular, rotationally symmetrical piece, whose outer surface is preferably a straight cylinder in that portion of the first end 13a which is placed inside the new air pipe 7a. The opposite, second end 13c of the fastening sleeve blank 13 is larger than the first end 13a in diameter, so that the fastening sleeve blank would contain sufficient material for machining. Consequently, the second end 13c comprises the material blank to be machined and fitted to match the method of fixing. Preferably, a collar 13b is also provided between the ends 13a, 13b, which collar has a diameter larger than the first end 13a and against which the end of the new air pipe 7a is placed. The collar 13b and the new air pipe are sealed by welding them together. Preferably, the diameter of the collar 13b is smaller than the outer diameter of the new air pipe 7a. The outer diameter of the first end 13a corresponds substantially to the inner diameter of the new air pipe 7a.

The new air pipe with the fastening sleeve blank 13 is connected to a suitable machine tool, for example a lathe, and the second end 13c of the fastening sleeve blank 13 is machined to be parallel and concentric with the new air pipe 7a. During machining, the diameter of the second end 13c of the fastening sleeve blank 13 is reduced, and either a straight cylinder is formed, whose outer diameter corresponds substantially to the inner diameter of the old air pipe 7b, or a right cone 13d is formed, whose outer diameter decreases in the direction towards the outer second end 13c of the fastening sleeve blank 13 which is placed inside the old air pipe 7b, as shown in FIG. 7. Typically, after cutting off the air pipe 7, wherein the old air pipe 7b remains, the end of the old air pipe 7b must be straightened and calibrated in view of its inner surface, to secure reliable installation and sealing. If necessary, a seam formed in connection with the manufacture of the air pipe 7 is removed from the inner surface. The straightening and calibration applies to a portion of 15 mm or longer on the inner surface of the old air pipe 7b. The straightening and calibration can be performed by methods known as such, for example by a machine tool for a tube end.

One or more gaskets 13f, which are preferably flexible, are provided between the fastening sleeve 13 and the air pipe 7. On the surface of the cone 13d or cylinder, or at its direct vicinity, one or more grooves are provided, in which a gasket 13f, for example an O-ring, can be placed between the fastening sleeve 13 and the air pipe 7, to seal the clearance between the fastening sleeve 13 and the air pipe 7. The outer diameter of the cone 13d and the inclination of the flank are selected so that the end of the old air pipe 7b will adhere tightly and with a sufficient frictional force to the fastening sleeve 13, when the fastening sleeve 13 connected to the new air pipe 7a is forced into the old air pipe 7b. The forcing is performed by methods known as such, for example by placing a mandrel at the end of the new air pipe 7a and by hitting with a hammer.

The inclination of the cone 13d is, in one example, only 1 to 2 degrees. Behind the cone or cylinder, in the outermost part of the second end 13c, for example another straight cylinder 13e can be machined, whose outer diameter is suitably selected according to the size of the air pipe.

Before joining the old and new air pipe, the end plate 10 has been fixed in place and the new air pipe 7a has been inserted in an opening in the end plate 10. After the parts of the air pipe have been joined together, the air pipe 7 is fastened to the end plate 10, for example by mangling or welding in such a way that no gaps leading to the flue gas duct are left between the end plate 10 and the air pipe 7. In some examples, a protective sleeve is also placed around the air pipe 7, extending through the end plate and welded to the end plate. Various gaskets can be applied between the protective sleeve, the air guide sleeve and the air pipe to prevent leaks of flue gases out of the flue gas duct.

As already mentioned above, it is also possible to manufacture totally new heat exchanger units for a preheater 3 in the above-presented way. In such a case, the whole air pipe is made by the above-described method by using parts of the air pipe but excluding the cutting. Thus, a component is used which comprises a fastening sleeve and a new air pipe, or a fastening sleeve blank and an air pipe. Consequently, a corresponding component can also be utilized for repairing an old air pipe or for replacing an old air pipe with a new one.

The methods and structures presented above in connection with various embodiments shall not be interpreted as examples limiting the application, but the presented solution can be applied within the scope defined in the appended claims.

1. A method for the installation of air pipes for a flue gas air preheater (3), wherein a set of air pipes (7) is connected to said preheater, characterized by
cutting an air pipe (7) connected to the preheater and detaching the portion of the air pipe (7) that is to be removed from the preheater for replacement,
fitting a separate new air pipe (7a) in place of the air pipe portion to be removed, and
connecting said new air pipe (7a) to the remaining portion (7b) of the air pipe (7) in a sealed manner, as an extension of it.

2. The method according to claim 1, characterized by connecting said new air pipe (7a) to the preheater.

3. The method according to claim 1 or 2, characterized by fixing said new air pipe (7a) to the remaining portion of the air pipe (7) by utilizing a fastening sleeve (13) fixed to the end of the new air pipe (7a) and inserting it in the remaining portion (7b) of the air pipe (7).

4. The method according to claim 3, characterized by connecting the remaining portion (7b) to the fastening sleeve (13) by means of a mechanical sealing solution (13d, 13f) without welding.

5. The method according to claim 3 or 4, characterized by connecting the remaining portion (7b) to the fastening sleeve (13) by means of a conical surface (13d) on the outer surface of said fastening sleeve (13).

6. The method according to claim 5, characterized by fitting one or more flexible gaskets (13f) between the remaining portion (7b) and the fastening sleeve (13) to separate the inner space of the air pipe (7) from the space outside the air pipe (7).

7. The method according to any of the claims 3 to 6, characterized by installing said new air pipe (7a) and fastening sleeve (13) to the remaining portion (7b) of the air pipe (7) in such a way that the new air pipe (7a) and the fastening sleeve (13) constitute a finished air pipe component, whose fastening sleeve (13) is a blank to be machined, which blank is, for the installation, machined to a form in which the fastening sleeve (13) is fitted to extend into the remaining portion (7b) of the air pipe (7).

8. The method according to claim 1 or 2, characterized by fixing said new air pipe (7a) to the remaining portion of the air pipe (7) by utilizing a right cone formed at the end of the new air pipe (7a), which right cone is inserted in the remaining portion (7b) of the air pipe (7), and by fixing the remaining portion (7b) to said right cone by means of the conical surface (13d) on the outer surface of said right cone.

9. The method according to claim 8, characterized by connecting the remaining portion (7b) to said right cone by means of a mechanical sealing solution (13d, 13f) without welding.

10. A flue gas air preheater (3) provided with a set of air pipes (7), characterized in that at least one of said air pipes (7) comprises:
a first portion (7b) of the air pipe (7), and
a separate second portion (7a) of the air pipe (7), connected to the first portion (7b) in a sealed manner, as an extension of it.

11. The preheater according to claim 10, characterized in that the second portion (7a) is connected to the first portion (7b) by means of a fastening sleeve (13) connected to the end of the second portion (7a) and inserted in the first portion (7b).

12. The preheater according to claim 10 or 11, characterized in that the first portion (7b) is connected to the fastening sleeve (13) by means of a mechanical sealing solution (13d, 13f) without welding.

13. The preheater according to claim 10, characterized in that the second portion (7a) is connected to the first portion (7b) by utilizing a right cone formed at the end of the second portion (7a), which cone is inserted in the first portion (7b), and the remaining portion (7b) is connected to said right cone by means of the conical surface (13d) on the outer surface of said right cone.

14. The preheater according to claim 13, characterized in that the first portion (7b) is connected to said right cone by means of a mechanical sealing solution (13d, 13f) without welding.

15. An air pipe component for a flue gas air preheater (3), characterized in that said air pipe component comprises:
an air pipe (7a), and
a fastening sleeve (13) with a first end (13a) inserted in the first portion (7a) and connected to the end of the first portion (7a), as an extension of it.

16. The air pipe component according to claim 11, characterized in that the first end (13a) has been connected to the end of the first portion (7a) by means of welding.

17. The air pipe component according to claim 11 or 12, characterized in that the fastening sleeve further comprises a second end (13c) provided as an extension to the said air pipe (7) and fitted to extend in another corresponding air pipe (7b) for fixing.

18. The air pipe component according to any of the claim 11 or 13, characterized in that the fastening sleeve further comprises a second end (13c) provided as an extension to the said air pipe (7), which second end is a blank to be machined, the blank being machined to a form, in which the fastening sleeve is fitted to extend in another corresponding air pipe (7b) for fixing.
